(19) United States
(12) Patent Application Publication
(10) Pub. No.: US 2008/0113114 A1
(43) Pub. Date: May 15, 2008

(54) Optical film, method of manufacturing optical film and liquid crystal display device including the same

(75) Inventors: Jeong Min Moon, Gyeonggi-do (KR); Byung Hwa Ji, Gyeonggi-do (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/797,329

(22) Filed: May 2, 2007

(30) Foreign Application Priority Data
Nov. 10, 2006 (KR) 10-2006-0110785

(51) Int. Cl. C09K 19/00; B29D 11/00; B32B 3/00; B32B 7/02

(52) U.S. Cl. 428/1.1; 264/210.7; 428/156; 428/212

(57) ABSTRACT

Provided are an optical film, a method of manufacturing the optical film, and a liquid crystal display device including the optical film. The optical film includes a multi-layer sheet. The multi-layer sheet includes a polymer layer having first and second refraction indexes in first and second stretching directions, respectively. A copolymer layer is formed on the polymer layer and has a third refraction index in the first and second stretching directions. A difference between the first and third refraction indexes is larger than a difference between the second and third refraction indexes.

This invention claims the benefit of Korean Patent Application No. 10-2006-0110785 filed in Korea on Nov. 10, 2006, which is hereby incorporated by reference in its entirety.

### BACKGROUND OF THE INVENTION

1. Field of the Invention

The present invention relates to an optical film, a method of manufacturing the optical film, and a liquid crystal display device including the same.

2. Description of the Related Art

Generally, a liquid crystal display device includes a thin film transistor substrate, a color filter substrate, a liquid crystal display panel having a liquid crystal layer interposed between the thin film transistor substrate and the color filter substrate, and backlight unit having a separate light source for supplying light to the liquid crystal display panel. The liquid crystal display device includes a polarizer formed on at least one of the top and bottom surfaces of the liquid crystal display panel. The backlight unit includes the light source emitting light and optical films directing the light emitted from the light source toward the top surface of the liquid crystal display panel. The optical films include at least one of a diffusion film, a prism film, and a protection film. Although light emitted from the light source is directed to the polarizer through the optical films, only some of the light having a polarization direction parallel to a transmission axis of the polarizer is transmitted through the polarizer.

Light polarized by the polarizer is incident onto the liquid crystal display panel and is modulated according to the molecular arrangement of the liquid crystal layer of the liquid crystal display panel. Thus, an image can be displayed on a screen of the liquid crystal display device. Other components of the light that are blocked by the polarizer are reflected from the polarizer or absorbed by the polarizer. Therefore, a large portion of light emitted from the light source dose not reach the liquid crystal display panel. As a result, the overall brightness of the backlight is not used, and more power is required for the backlight unit to provide sufficient brightness to the liquid crystal display device.

### SUMMARY OF THE INVENTION

Accordingly, embodiments of the invention are directed to an optical film, a method of manufacturing the optical film, and a liquid crystal display device including the same that substantially obviate one or more problems due to limitations and disadvantages of the related art.

An object of embodiments of the invention is to improve the optical efficiency of a liquid crystal display device, to increase the brightness of the liquid crystal display device, and to reduce the power consumption of a backlight assembly.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, an optical film comprising a multi-layer sheet, wherein the multi-layer sheet includes a polymer layer, including polyethylene terephthalate, the polymer layer having first and second refraction indexes in first and second stretching directions, respectively, the first and second stretching directions being parallel to a plane of the polymer layer, and a copolymer layer on the polymer layer and including a polyethylene terephthalate copolymer, the copolymer layer having a third refraction index in the first and second stretching directions, wherein a difference between the first and third refraction indexes is larger than a difference between the second and third refraction indexes, and the multi-layer sheet has a first draw ratio in the first stretching direction greater than a second draw ratio in the second stretching direction.

In another aspect, an optical film having a multi-layer sheet includes polymer layers having a first refraction index in a first direction parallel to a plane of the polymer layer and a second refraction index in a second direction parallel to the plane of the polymer layer, and copolymer layers having a third refraction index in both the first and second directions, wherein the polymer layers and the copolymer layers are stacked for transmitting a first component of light incident onto the multi-layer sheet and reflecting a second component of the incident light.

In another aspect, an optical film having a multi-layer sheet includes a plurality of polyethylene terephthalate polymer layers, the polymer layers having a first refraction index in a first stretching direction parallel to a plane of the polymer layers and a second refraction index in a second stretching direction parallel to the plane of the polymer layers, and a plurality of polyethylene terephthalate copolymer layers, the copolymer layers having a third refraction index in both the first and second stretching directions, wherein the polymer layers and the copolymer layers are stacked for transmitting a first component of light incident onto the multi-layer sheet and reflecting a second component of the incident light.

In another aspect, an optical film having a multi-layer sheet includes a plurality of polyethylene terephthalate polymer layers, the polymer layers having a first refraction index in a first direction parallel to a plane of the polymer layers and a second refraction index in a second direction parallel to the plane of the polymer layers, and a plurality of polyethylene terephthalate copolymer layers, the copolymer layers having a third refraction index in both the first and second directions.

In another aspect, an optical film having a multi-layer sheet includes a plurality of polymer layers, the polymer layers including polyethylene terephthalate and having a first refraction index in a first stretching direction parallel to a plane of the polymer layers and a second refraction index in a second stretching direction parallel to the plane of the polymer layers, and a plurality of copolymer layers, the copolymer layers including polyethylene terephthalate copolymer and having a third refraction index in both the first and second stretching directions, wherein the polymer layers and the copolymer layers have a varying thickness.

In another aspect, a method of fabricating an optical sheet includes preparing a polymer including polyethylene terephthalate, preparing a copolymer including polyethylene terephthalate and an additive material, melting and extrusion-processing each of the polymer and copolymer in layered shape, alternately stacking the extrusion-processed polymer and copolymer, multiplying the number of layers of the polymer and copolymer in a multiplier, stretching the stacked polymer and copolymer in a first stretch direction, and stretching the first stretched polymer and copolymer in a second stretch direction, the polymer layers having first and second refraction indexes in the first and second stretching directions, respectively, and the copolymer layer having a third refraction index in the first and second stretching directions.

In another aspect, a liquid crystal display device includes a liquid crystal display panel for displaying images, a reflector for reflecting light, a backlight assembly between the reflector and the liquid crystal panel for irradiating light onto the liquid crystal display panel; and an optical film having a multi-layer sheet including: polymer layers having first refraction index in a first direction parallel to a plane of the polymer layer and a second refraction index in a second direction parallel to the plane of the polymer layer, and copolymer layers having a third refraction index in both the first and second directions, wherein the polymer layers and the copolymer layers are stacked, and the reflector is positioned such that a first component of light incident onto the multi-layer sheet is reflected as a reflected first component of light to the reflector while a second component of the incident light is transmitted through the multi-layer sheet, and then at least some of the reflected first component of the light is reflected and converted by the reflector into a converted second component of light such that the converted second component is transmitted through the multi-layer sheet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a portion of an optical film according to an embodiment of the present invention;

FIG. 2A is a side view illustrating the optical film of FIG. 1 along a first stretching direction;

FIG. 2B is a side view illustrating the optical film of FIG. 1 along a second stretching direction;

FIG. 3 is a cross-sectional view illustrating how an optical film shrinks by a residual stress according to an embodiment of the present invention;

FIGS. 4A to 4C are perspective views for explaining a method of manufacturing an optical film according to an embodiment of the present invention;

FIG. 5 is a flowchart for explaining a method of manufacturing an optical film according to an embodiment of the present invention; and

FIG. 6 is a schematic cross-sectional view illustrating a liquid crystal display device according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

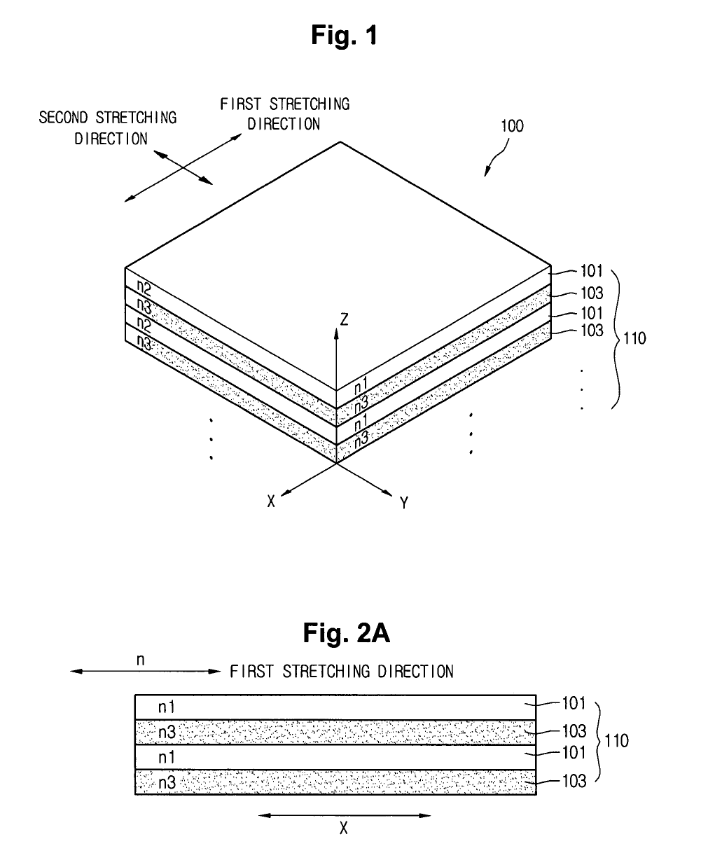

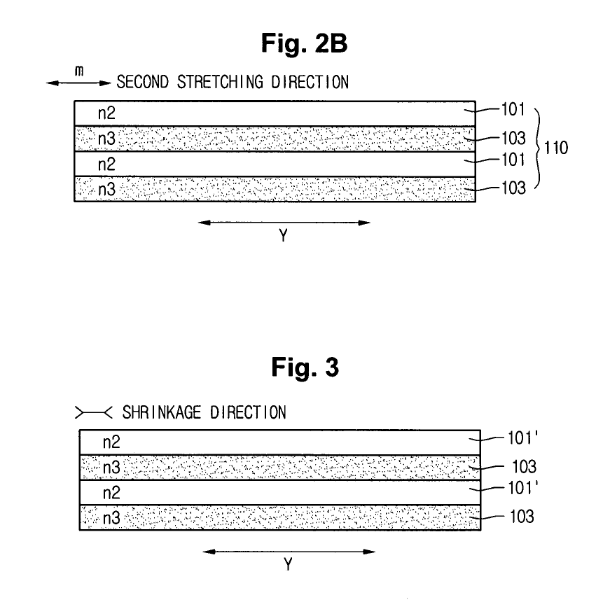

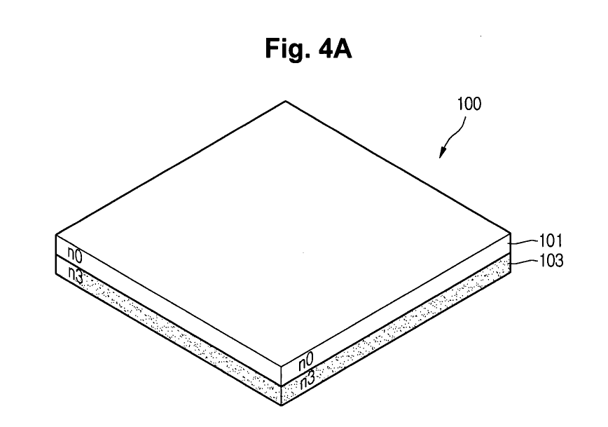

FIG. 1 is a perspective view illustrating a portion of an optical film 100 according to an embodiment of the present invention, FIG. 2A is a side view illustrating the optical film 100 of FIG. 1 along a first stretching direction, and FIG. 2B is a side view illustrating the optical film 100 of FIG. 1 along a second stretching direction. Referring to FIG. 1, the optical film 100 includes a multi-layer sheet 110. The multi-layer sheet 110 includes a plurality of polymer layers 101 and a plurality of copolymer layers 103 interposed between the polymer layers 101 in an alternating manner. The polymer layers 101 have a first refraction index n1 in a first stretching direction and a second refraction index n2 in a second stretching direction. The copolymer layers 103 have a third refraction index n3 in the first and second stretching directions.

The difference between the first refraction index n1 and the third refraction index n3 is larger than the difference between the second refraction index n2 and the third refraction index n3. The first refraction index n1 is larger than the third refraction index n3, and the second refraction index n2 is larger than the third refraction index n3. The first refraction index n1 is larger than the second refraction index n2.

When the polymer layers 101 of the optical film 100 are stretched, the refraction characteristics of the polymer layers 101 vary in the axis of stretching. The term “stretching” is used herein to denote a process of applying a physical force to the polymer layers 101 to stretch the polymer layers 101 in a predetermined direction. When the polymer layers 101 are stretched in a predetermined direction, the refraction index of the polymer layers 101 changes in the predetermined direction. Thus, the polymer layers 101 can have a birefringence index. The refraction index of the polymer layers 101 may vary with the draw ratio of the polymer layers 101. Approximately, the refraction index of the polymer layers 101 increases in proportion to the draw ratio of the polymer layers 101.

FIG. 2A is a side view illustrating the optical film of FIG. 1 along a first stretching direction and FIG. 2B is a side view illustrating the optical film of FIG. 1 along a second stretching direction. As shown in FIGS. 2A and 2B, the multi-layer sheet 110 is stretched until the draw ratio of the multi-layer sheet 110 becomes (n) (n>0) in the first stretching direction and (m) (m>0) in the second stretching direction. As a result, the refraction index of the multi-layer sheet 110 changes with a draw ratio. The first and second stretching directions can be orthogonal to each other. Alternatively, the first and second stretching directions can cross each other at other angles. When the draw ratio (n) in the first stretching direction is larger than the draw ratio (m) in the second stretching direction, the polymer layers 101 have a first refraction index n1 in the first stretching direction and a second refraction index n2 in the second stretching direction, and the copolymer layers 103, which are disposed between the polymer layers 101 in turns, have a third refraction index n3 in the first and second stretching directions.

When an axis parallel with the multi-layer sheet 110 is defined as an X-axis, a Y-axis parallel with the multi-layer sheet 110 and perpendicular to the X-axis can be defined. Further, a Z-axis perpendicular to the multi-layer sheet 110 can be defined. Then, the first stretching direction is parallel with the X-axis, and the second stretching direction is parallel with the Y-axis. Since the polymer layers 101 have the first refraction index n1 in the X-axis, the second refraction index n2 in the Y-axis, and a refraction index (not defined) in the Z-axis, the polymer layers 101 can be birefringence layers.

The optical film 100 transmits only a predetermined component of light incident onto the optical film 100. Other components of the light incident onto the optical film 100 are reflected since the optical film 100 has different refraction indexes in two directions, as described above. The thickness of the optical film 100 can be adjusted to obtain optimized performance. Further, the thicknesses of the polymer layers 101 and the copolymer layers 103 can be adjusted, respectively.

The polymer layers 101 and the copolymer layers 103, which are alternately stacked in the optical film 100, can have different thickness in the Z-axis direction. For example, the polymer layers 101 can increase in thickness as they goes from outside to inside of the optical film 100. Further, the copolymer layers 103 can increase in thickness as they go from outside to inside of the optical film 100. Alternatively, the polymer layers 101 can decrease in thickness as they go from outside to inside of the optical film 100, and the copolymer layers 103 can decrease in thickness as they go from outside to inside of the optical film 100.

The multi-layer sheet 100 formed by alternately stacking the polymer layers 101 and the copolymer layers 103 is characterized in that a first component of light incident onto the multi-layer sheet 110 is reflected while a second component of the incident light is transmitted through the multi-layer sheet 110. In other words, pairs of the polymer layer 101 and the copolymer layer 103 are stacked such that alternately arranged polymer layers 101 and the copolymer layers 103 reflect a first component of light incident onto the multi-layer sheet 110 while a second component of the incident light is transmitted through the multi-layer sheet 110.

For example, a light source generates light having a p-wave component and an s-wave component, and the optical film 100 transmits the p-wave component of light to a liquid crystal display panel and reflects the s-wave component of the light. The s-wave component reflected from the optical film 100 is then incident onto a reflector disposed at the back of the optical film 100. The reflector subsequently changes the phrase of a portion of the reflected s-wave component of light into p-wave component. As a result, the reflected light then includes a first remaining portion of s-wave component and a converted portion of p-wave component, and the reflector reflects such light back to the optical film 100. Thus, the optical film 100 transmits the converted portion of p-wave component onto the liquid crystal display panel. Moreover, as the optical film 100 transmits the converted portion of p-wave component, the optical film 100 also reflects the first remaining portion of s-wave component back to the reflector. In particular, the first remaining portion of s-wave component is smaller than the previous reflected portion of light. Further, the first remaining portion of s-component component of light is again incident on the reflector and a portion of such light is converted into p-wave component to be transmitted through the optical film 100. Therefore, a portion of the reflected s-wave component of light is recycled and transmitted through the optical film 100 as a p-wave component of light, thereby improving optical efficiency.

The s-wave component and p-wave component of light can be perpendicular to each other and vibrate with respect to a traveling direction of light. For example, light can be incident onto the optical film 100 in the Z-axis direction, and the s-wave component and p-wave component can vibrate in X-axis and Y-axis directions. Preferably, the vibration direction of the s-wave component is parallel with the first stretching direction of the multi-layer sheet 110, and the vibration direction of the p-wave component is parallel with the second stretching direction of the multi-layer sheet 110.

An entrance surface of the multi-layer sheet 110 onto which light is incident can be formed of any one of the polymer layer 101 and the copolymer layer 103. Further, an exit surface of the multi-layer sheet 110 from which light leaves the multi-layer sheet 110 can be formed of any one of the polymer layer 101 and the copolymer layer 103. The polymer layer 101 includes polyethylene terephthalate (PET). The copolymer layer 103 includes at least one material selected from the group consisting of PET, polytrimethylene terephthalate (PTT), polyethylene naphthalate (PEN), PET copolymer, PTT copolymer, and PEN copolymer.

When the polymer layers 101 of the optical film 100 are formed of PET, copolymer layers 103 disposed between the polymer layers 101 in an alternating manner can be formed of a PET copolymer. The copolymer layer 103 can be formed of more than or equal to 50 weight % of PET (e.g., about 80 weight % of PET) and less than or equal to 50 weight % of an additive material (e.g., about 20 weight % of an additive material) by copolymerization. The additive material can be PEN.

The optical film 100 may include at least one polymer layer 101 and at least one copolymer layer 103. For example, tens of several tens to several thousands of layers can be alternately stacked to form the optical film 100. The first refraction index n1 of the polymer layer 101 may be different from the third refraction index n3 of the copolymer layer 103 by 0.01 or more. Alternatively, the first refraction index n1 of the polymer layer 101 may be different from the third refraction index n3 of the copolymer layer 103 by 0.5 or less.

The multi-layer sheet 110, in which the polymer layers 101 and the copolymer layers 103 are alternately stacked, can be stretched in the first stretching direction (single-axis elongation). In the alternative, the multi-layer sheet 110, in which the polymer layers 101 and the copolymer layers 103 are alternately stacked, can be stretched in the first stretching direction and then in the second stretching direction (two-axis elongation). When the multi-layer sheet 110 is stretched at least one time, the multi-layer sheet 110 can be undesirably shrunken due to a residual stress after a subsequent heat-set process. However, in embodiments of the present invention, the multi-layer sheet 110 is not deteriorated due to bending or wrinkles although the multi-layer sheet 110 is shrunken by a residual stress. Moreover, the mechanical characteristics of the optical film 100 are improved.

In the current embodiment, the multi-layer sheet 110 is stretched twice in two directions (two-axis elongation), for example. However, embodiments of the present invention are not limited to the two-axis elongation. The multi-layer sheet 110 can be stretched two or more times to improve optical characteristics of the optical film 100. In addition, although the multi-layer sheet 110 can be stretched twice in perpendicular directions, the multi-layer sheet 110 can be stretched twice in non-perpendicular directions.

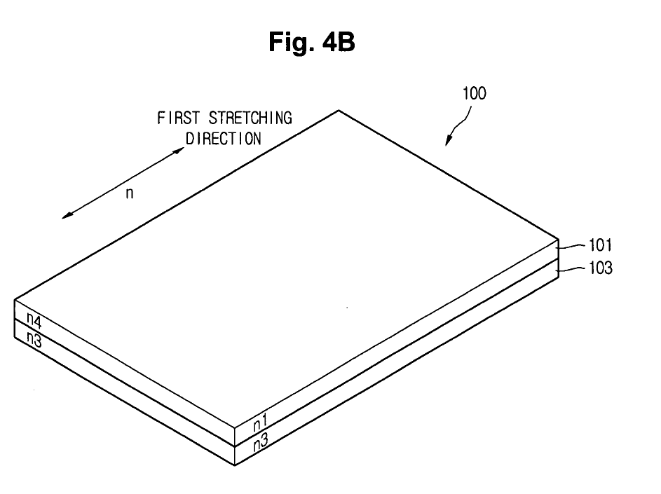

FIG. 3 is a cross-sectional view illustrating how an optical film shrinks by a residual stress according to an embodiment of the present invention. Referring to FIG. 3, when the multi-layer sheet 110 is stretched by a physical force, the multi-layer sheet 110 can shrink in a direction perpendicular to the stretching direction due to a residual stress before a heat-set process is performed on the stretched sheet 110. When an optical film shrinks, optical characteristics of the optical film can deteriorate or unexpected results can occur. However, in embodiments of the present invention, since the optical film 100 is stretched in two or more directions (two-axis or multi-axis elongation), the optical film 100 can maintain good heat-resistant characteristics and mechanical strength without wrinkles or bending although the optical film 100 is shrinks as a side effect of stretching.

For example, the multi-layer sheet 110 is stretched in the first stretching direction (main stretching direction) and then in the second stretching direction. The multi-layer sheet 110 may shrink in a direction perpendicular to the first or second stretching direction. The shrinkage ratio of the optical film 100 can be equal to or less than one of the draw ratio (n) of the optical film 100 in the first stretching direction or the draw ratio (m) of the optical film 100 in the second stretching direction. That is, polymer layers 101′ and copolymer layers 103′ of the optical film 100 may be shrink by an amount equal to or less than the amount that the polymer layers 101′ and copolymer layers 103′ of the optical film 100 were stretched.

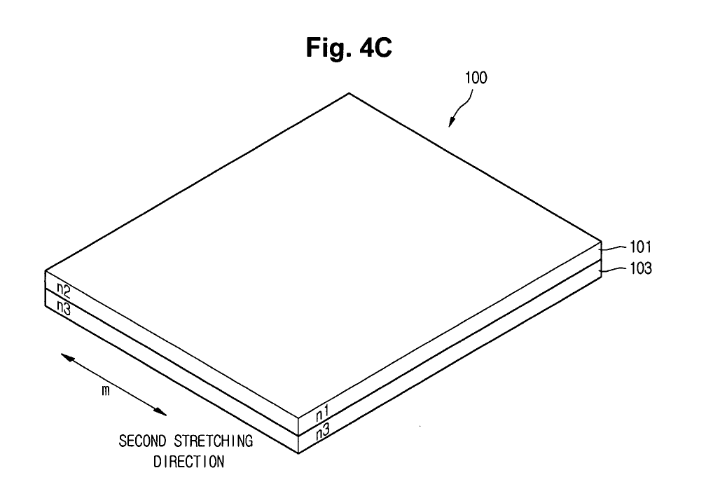

FIGS. 4A to 4C are perspective views for explaining a method of manufacturing an optical film according to an embodiment of the present invention. Referring to FIG. 4A, a polymer layer 101 and a copolymer layer 103 are formed by extrusion molding using a polymer material and a copolymer material. The polymer layer 101 and the copolymer layer 103 are alternately stacked. The polymer layer 101 and the copolymer layer 103 can be repeatedly stacked to form a non-stretched multi-layer sheet 108. The polymer layer 101 has a first initial refraction index n0 with respect to an X-Y plane, and the copolymer layer 103 has a second initial refraction index n3 with respect to the X-Y plane. The first initial refraction index n0 may be substantially equal to the second refraction index n3.

Then, as shown in FIG. 4B, the non-stretched multi-layer sheet 108 (shown in FIG. 4A) formed of the polymer layer 101 and the copolymer layer 103 is stretched in a first stretching direction to result a single-stretched multi-layer sheet 109. After that, the polymer layer 101 has a first refraction index n1 in the first stretching direction, and the copolymer layer 103 still has the second initial refraction index n3. At this time, the polymer layer 101 can have an other refraction index n4 in a direction different from the first stretching direction. The other refraction index n4 can be larger than the first initial refraction index n0 or substantially equal to the first initial refraction index n0. Here, the first stretching direction is an X-axis direction, and the thickness of the single-stretched multi-layer sheet 109 formed of the polymer layer 101 and the copolymer layer 103 may be decreased in a Z-axis direction since the polymer layer 101 and the copolymer layer 103 are stretched in the X-axis direction. The single-stretched multi-layer sheet 109 is stretched to a draw ratio (n) (n>0) in the first stretching direction. For example, the single-stretched multi-layer sheet 109 is stretched in the first stretching direction to a length three to eight times larger than the original length of the non-stretched multi-layer sheet 108.

Subsequently, as shown in FIG. 4C, the single-stretched multi-layer sheet 109 (shown in FIG. 4B) is stretched in a second stretching direction to result a multi-layer sheet 110. After that, the polymer layer 101 has a second refraction index n2 in the second stretching direction, and the copolymer layer 103 has a third refraction index n3 in the second stretching direction. The multi-layer sheet 110 is stretched to a draw ratio (m) (n>m) in the second stretching direction. For example, the multi-layer sheet 110 is stretched in the second stretching direction to a length 0.1 to 1.5 times larger than the original length of the single-stretched multi-layer sheet 109 (shown in FIG. 4B). Then, the resultant double-stretched multi-layer sheet 110 is treated in a heat-set process to form the optical film 100.

The first stretching direction may be orthogonal to the second stretching direction. However, the first and second stretching directions can be differently defined as long as the first and second stretching directions are different. Further, protection sheets can be formed on top and bottom surfaces of the optical film 100.

The protection sheets may include a polyester-based polymer layer or polycarbonate. In the alternative, the protection sheets may include a polyester-based copolymer layer. Adhesive layers can be disposed between the multi-layer sheet 110 and the protection sheets. The adhesive layers can be formed of an acrylic-based or polyester-based material. The adhesive layers are used to attach the protection sheets to the multi-layer sheet 110. However, the protection sheets can be formed on the multi-layer sheet 110 without using adhesive layers. For example, before the multi-layer sheet 110 is stretched in the first stretching direction, a protection sheet material can be formed on one or both sides of the multi-layer sheet 110 by coextrusion to form a protection sheet on the multi-layer sheet 110 without using an adhesive layer. In this case, the protection sheet is stretched together with the multi-layer sheet 110 in one direction or two directions (single-axis or two-axis elongation).

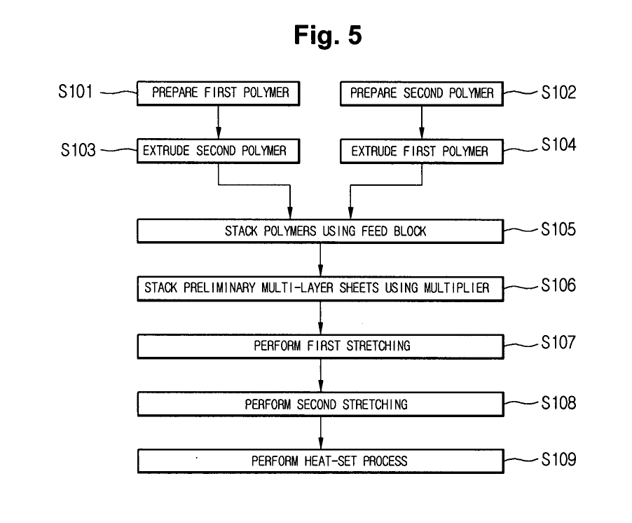

FIG. 5 is a flowchart for explaining a method of manufacturing an optical film according to an embodiment of the present invention. First and second polymers are prepared in operations S101 and S102. For example, the first polymer may be PET. The second polymer is formed of the first polymer by copolymerization. For example, the second polymer may be co-PET. The second polymer may be formed of more than or equal to 50 weight % of PET (e.g., about 80 weight % of PET) and less than or equal to 50 weight % of an additive material (e.g., about 20 weight % of an additive material) by copolymerization. The additive material can be PEN.

In operation S103, the first polymer is fused in a first extruder and extruded from the first extruder in the form of a film. Alternately, in operation S104, the second polymer is fused in a second extruder and extruded from the second extruder in the form of a film. In operation S105, the extruded first and second polymers are alternately stacked in a feed block. The feed block is a device used for manufacturing a multi-layer film. In the feed block, the first and second polymers can be alternately stacked without mixing. For example, the first and second polymer layers may be alternately stacked to form a preliminary multi-layer sheet having two hundred twenty layers.

In operation S106, the preliminary multi-layer sheet is introduced into a multiplier. In the multiplier, a plurality of preliminary multi-layer sheets is stacked to increase the number of layers of the preliminary multi-layer sheet by several times. For example, four preliminary multi-layer sheets each having the two hundred twenty first and second polymer layers are stacked to form a multi-layer sheet having eight hundred eighty layers.

In operation S107, the multi-layer sheet is taken out of the multiplier and is first stretched. Here, the first polymer layers of the multi-layer sheet have a uniform refraction index in x and y-axis directions parallel to the plane of the multi-layer sheet, and the second polymer layers of the multi-layer sheet have a uniform refraction index in the x and y-axis directions. The first and second polymer layers can have substantially the same refraction index. The first stretching is performed to elongate the multi-layer sheet in a first stretching direction. The first stretching direction can be equal to a moving direction of the multi-layer sheet. Alternatively, the first stretching direction can be different from the moving direction of the multi-layer sheet.

After the multi-layer sheet is stretched in the first stretching direction, the refraction index of the first polymer layers of the multi-layer sheet changes to a first refraction index n1 in the first stretching direction. However, the second polymer layers of the multi-layer sheet do not change in refraction index.

In operation S108, the multi-layer sheet is stretched in a second direction different from the first stretching direction. The second stretching direction can be orthogonal to the first stretching direction. After the multi-layer sheet is stretched in the second stretching direction, the refraction index of the first polymer layers of the multi-layer sheet have a second refraction index n2 in the second stretching direction, and the refraction index of the second polymer layers of the multi-layer sheet does not differ in the stretching directions. For example, after the operations S107 and S108, the second polymer layers have a third refraction index n3 in both the first and the second stretching directions. Optionally, the multi-layer sheet can be further stretched in other directions.

The first and second stretching directions can be selected in various combinations, and the draw ratio of the multi-layer sheet can selected from various values. For example, the multi-layer sheet can be stretched to a length three to eight times larger than its original length in the first stretching direction (here, draw ratio in the first stretching direction is n (n>0)), and the multi-layer sheet can be stretched to a length 0.1 to 1.5 times larger than its original length in the second stretching direction (here, draw ratio in the second stretching direction is m (n>m)). Alternatively, the multi-layer sheet can be stretched to a length 0.1 to 1.5 times larger than its original length in the first stretching direction, and the multi-layer sheet can be stretched to a length three to eight times larger than its original length in the second stretching direction. That is, the multi-layer sheet can have a draw ratio p (p>0) in the first stretching direction and a draw ratio q (q>p) in the second stretching direction. A difference between the first refraction index n1 and the third refraction index n3 can be larger than a difference between the second refraction index n2 and the third refraction index n3.

Thereafter, in operation S109, the multi-layer sheet is treated in a heat-set process. As a result, formation of an optical film by a stretching process is complete. After the first and second stretching, mechanical characteristics of the multi-layer sheet are improved. Further, optical characteristics of the optical film formed of the multi-layer sheet do not change much after the stretching process, even when the multi-layer sheet shrinks or expands due to environmental agents.

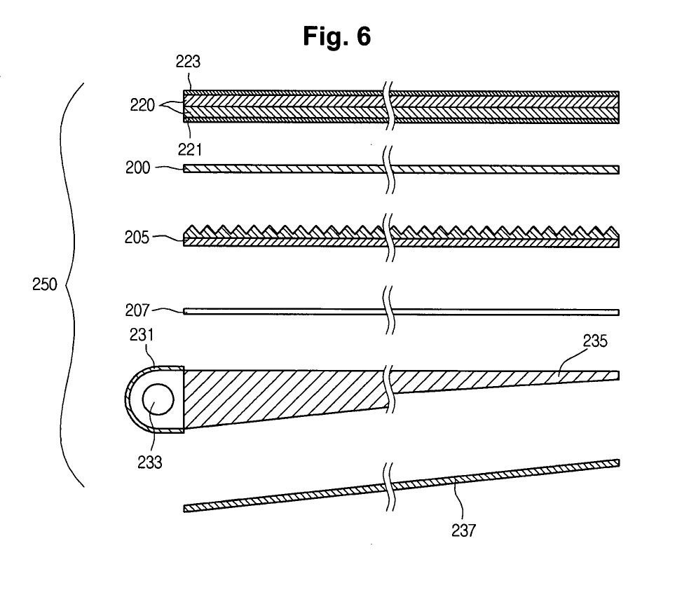

FIG. 6 is a schematic cross-sectional view illustrating a liquid crystal display device according to an embodiment of the present invention. Referring to FIG. 6, the liquid crystal display device includes a liquid crystal display panel 220 for displaying images and a backlight assembly 250 disposed at the back of the liquid crystal display panel 220 for irradiating light to the liquid crystal display panel 220. Upper and lower polarizer 223 and 221 are on top and bottom surfaces of the liquid crystal display panel 220.

The backlight assembly 250 includes a lamp 233 as a light source, a light guide plate 235 guiding light from the lamp 233 to the liquid crystal display panel 220, and a plurality of optical sheet for improving brightness of the liquid crystal display device. The lamp 233 is disposed at a side portion of the light guide plate 235, and light emitted from the lamp 233 enters into the light guide plate 235 from the side portion of the light guide plate 235. A lamp reflector 231 is formed at the side portion of the light guide plate 235 to enclose the lamp 233. Light emitted from the lamp 233 in a direction away from the side portion of the light guide plate 235 is reflected to the light guide plate 235 by the lamp reflector 231, so that optical efficiency can be improved. The light guide plate 235 guides light from the lamp 233 to the liquid crystal display panel 220 disposed in front of the light guide plate 235. Various patterns such as fine dot patterns are printed on a bottom surface of the light guide plate 235 in order to guide light from the lamp 233 to the liquid crystal display panel 220.

A diffusion sheet 207, a prism sheet 205, and an optical film 200 for improving optical efficiency are disposed between the light guide plate 235 and the liquid crystal display panel 220. The optical film 200 as described in FIGS. 1 through 4C. The optical film 200 includes a polymer layer and a copolymer layer. The polymer layer has first and second refraction indexes n1 and n2 in first and second stretching directions, respectively. The first and second stretching directions are parallel to a plane of the polymer layer. The copolymer layer is formed on the polymer layer and has a third refraction index n3 in the first and second stretching directions. A difference between the first and third refraction indexes n1 and n3 is larger than a difference between the second and third refraction indexes n2 and n3. At least one of the polymer layer and the copolymer layer has a birefringence index.

The diffusion sheet 207 diffuses light incident from the light guide plate 235 to prevent local concentrations of light. Therefore, light can be uniformly irradiated onto the liquid crystal display panel 220.

The prism sheet 205 includes a plurality of prisms formed on a surface facing the liquid crystal display panel 220 at a predetermined pitch. Light diffused by the diffusion sheet 207 is condensed onto the liquid crystal display panel 220 by the prism sheet 205 so that brightness of the front surface of the liquid crystal display panel 220 can be increased.

A reflector 237 is disposed under the back light assembly at the back of the light guide plate 235. Light discharged from the bottom surface of the light guide plate 235 is reflected back to the light guide plate 235 by the reflector 237, thereby improving optical efficiency. Further, the reflector 237 reflects light from the optical film 200 back to the optical film 200.

The backlight assembly 250 is shown in FIG. 6 as a side-type backlight unit. Although not shown, the backlight assembly 250 may be of a direct-type backlight unit and may have one or more light sources above the reflector 237 or in the same plane as the reflector 237.

The optical film 200 transmits and reflects light incident thereon depending on the polarization of the light. For example, the lamp 223 generates light having a p-wave component and an s-wave component. The optical film 200 transmits the p-wave component of light emitted from the lamp 233 toward the liquid crystal display panel 220 and reflects the s-wave component of the emitted light toward the light guide plate 235. The reflected s-wave component is then incident on the reflector 237 disposed at the back of the optical film 200. The reflector 237 subsequently converts a portion of the reflected s-wave component into a p-wave component. As a result, in addition to light emitted from the lamp 233, the reflector 237 also reflects a remaining portion of the reflected s-wave component and a converted portion of p-wave component to the optical film 200. As such, the converted p-wave component and the p-wave component of light emitted from the lamp 233 can pass through the optical film 200 and the reflector 237 repeatedly converts a portion of the reflected s-wave component into a transmittable p-wave component, thereby increasing optical efficiency. Thus, the brightness of the liquid crystal display device is increased and optical efficiency of the liquid crystal display device is improved.

The lower polarizer 221 can have a polarization axis in the same direction as a vibrating direction of the light (e.g., p-wave light) transmitted through the optical film 200. In this case, p-wave light from the optical film 200 can pass through the lower polarizer 221 and enter the liquid crystal display panel 220 for displaying an image so that the brightness of the liquid crystal display device can be increased. For given amount of power consumed by the backlight assembly 250, the optical efficiency of the liquid crystal display device can be improved by using the optical film 200. Therefore, power consumption of the backlight assembly 250 can be more efficiently utilized.

As described above, according to embodiments of the present invention, the optical film is formed by alternately stacking polymer layers and copolymer layers and is stretched in a first stretching direction and then in a second stretching direction. Therefore, the optical film can have good mechanical strength and heat-resistant characteristics. Further, the brightness and image-quality of the liquid crystal display device can be improved. In addition, since the liquid crystal display device has a good optical efficiency, backlight power consumption can be reduced by using a backlight have a lower brightness.

It will be apparent to those skilled in the art that various modifications and variations can be made in embodiments of the present invention. Thus, it is intended that the present invention covers the modifications and variations of this invention provided they come within the scope of the appended claims and their equivalents.

What is claimed is:

1. An optical film comprising a multi-layer sheet, wherein the multi-layer sheet comprises:
a polymer layer, including polyethylene terephthalate, the polymer layer having first and second refraction indexes in first and second stretching directions, respectively, the first and second stretching directions being parallel to a plane of the polymer layer; and
a copolymer layer on the polymer layer and including a polyethylene terephthalate copolymer, the copolymer layer having a third refraction index in the first and second stretching directions,
wherein a difference between the first and third refraction indexes is larger than a difference between the second and third refraction indexes, and the multi-layer sheet has a first draw ratio in the first stretching direction greater than a second draw ratio in the second stretching direction.

2. The optical film according to claim 1, wherein the difference between the first refraction index of the polymer layer and the third refraction index of the copolymer layer ranges from 0.01 to 0.5.

3. The optical film according to claim 1, wherein the difference between the second refraction index of the polymer layer and the third refraction index of the copolymer layer ranges from 0 to 0.1.

4. An optical film having a multi-layer sheet, comprising:
polymer layers having a first refraction index in a first direction parallel to a plane of the polymer layer and a second refraction index in a second direction parallel to the plane of the polymer layer; and
copolymer layers having a third refraction index in both the first and second directions,
wherein the polymer layers and the copolymer layers are stacked for transmitting a first component of light incident onto the multi-layer sheet and reflecting a second component of the incident light.

5. The optical film according to claim 4, wherein the polymer layers include polyethylene terephthalate and the copolymer layers include polyethylene terephthalate and at least one of polytrimethylene terephthalate and polyethylene naphthalate.

6. The optical film according to claim 4, wherein the first refraction index is larger than the third refraction index, and the second refraction index is larger than the third refraction index.

7. An optical film having a multi-layer sheet, comprising:
a plurality of polyethylene terephthalate polymer layers, the polymer layers having a first refraction index in a first stretching direction parallel to a plane of the polymer layers and a second refraction index in a second stretching direction parallel to the plane of the polymer layers; and
a plurality of polyethylene terephthalate copolymer layers, the copolymer layers having a third refraction index in both the first and second stretching directions,
wherein the polymer layers and the copolymer layers are stacked for transmitting a first component of light incident onto the multi-layer sheet and reflecting a second component of the incident light.

8. The optical film according to claim 7, wherein each of the copolymer layers includes more than or equal to 50 weight % of polyethylene terephthalate and less than or equal to 50 weight % of an additive material by copolymerization.

9. The optical film according to claim 8, wherein the additive material includes at least one of polytrimethylene terephthalate and polyethylene naphthalate.

10. An optical film having a multi-layer sheet, comprising:
a plurality of polyethylene terephthalate polymer layers, the polymer layers having a first refraction index in a first direction parallel to a plane of the polymer layers and a second refraction index in a second direction parallel to the plane of the polymer layers; and
a plurality of polyethylene terephthalate copolymer layers, the copolymer layers having a third refraction index in both the first and second directions.

11. The optical film according to claim 10, wherein each of the copolymer layers includes more than or equal to 50 weight % of polyethylene terephthalate (PET) and less than or equal to 50 weight % of an additive material by copolymerization.

12. An optical film having a multi-layer sheet, comprising:
a plurality of polymer layers, the polymer layers including polyethylene terephthalate and having a first refraction index in a first stretching direction parallel to a plane of the polymer layers and a second refraction index in a second stretching direction parallel to the plane of the polymer layers; and
a plurality of copolymer layers, the copolymer layers including polyethylene terephthalate copolymer and having a third refraction index in both the first and second stretching directions,
wherein the polymer layers and the copolymer layers have a varying thickness.

13. The optical film according to claim 12, wherein the polymer layers and the copolymer layers increase in thickness as they go from outside to inside of the multi-layer sheet.

14. The optical film according to claim 12, wherein the polymer layers and the copolymer layers decrease in thickness as they go from outside to inside of the multi-layer sheet.

15. The optical film according to claim 12, wherein the polymer layers and the copolymer layers are alternately stacked.

16. A method of fabricating an optical sheet, comprising:
preparing a polymer including polyethylene terephthalate;
preparing a copolymer including polyethylene terephthalate and an additive material;
melting and extrusion-processing each of the polymer and copolymer in layered shape;
alternately stacking the extrusion-processed polymer and copolymer;
multiplying the number of layers of the polymer and copolymer in a multiplier;
stretching the stacked polymer and copolymer in a first stretch direction; and
stretching the first stretched polymer and copolymer in a second stretch direction, the polymer layers having first and second refraction indexes in the first and second stretching directions, respectively, and the copolymer layer having a third refraction index in the first and second stretching directions.

17. The method according to claim 16, wherein a difference between the first and third refraction indexes is larger than a difference between the second and third refraction indexes, and the multi-layer sheet has a first draw ratio in the first stretching direction greater than a second draw ratio in the second stretching direction.

18. The method according to claim 16, further comprising: thermal treating the stretched first, second and third polymers.

19. A liquid crystal display device, comprising:
a liquid crystal display panel for displaying images;
a reflector for reflecting light;
a backlight assembly between the reflector and the liquid crystal panel for irradiating light onto the liquid crystal display panel; and
an optical film having a multi-layer sheet including:
polymer layers having first refraction index in a first direction parallel to a plane of the polymer layer and a second refraction index in a second direction parallel to the plane of the polymer layer; and
copolymer layers having a third refraction index in both the first and second directions,
wherein the polymer layers and the copolymer layers are stacked, and the reflector is positioned such that a first component of light incident onto the multi-layer sheet is reflected as a reflected first component of light to the reflector while a second component of the incident light is transmitted through the multi-layer sheet, and then at least some of the reflected first component of the light is reflected and converted by the reflector into a converted second component of light such that the converted second component is transmitted through the multi-layer sheet.

20. The device according to claim 19, wherein a difference between the first and third refraction indexes is larger than a difference between the second and third refraction indexes, and the multi-layer sheet has a first draw ratio in the first direction greater than a second draw ratio in the second direction.
